(19) United States
(12) Patent Application Publication
(10) Pub. No.: US 2007/0078063 A1
(43) Pub. Date: Apr. 5, 2007

(54) Subterranean treatment fluids and methods of treating subterranean formations

(75) Inventor: Trinidad Munoz JR., Duncan, OK (US)

Correspondence Address: Halliburton Energy Services, Inc., 2600 S. 2nd Street, Duncan, OK, 73536-0440, US

(73) Assignee: Halliburton Energy Services, Inc.

(21) Appl. No.: 11/634,319

(22) Filed: Dec. 5, 2006

Related U.S. Application Data
(63) Continuation-in-part of application No. 10/832,163, filed on Apr. 26, 2004.

(51) Int. Cl. C09K 8/00; E21B 43/00

(52) U.S. Cl. 507/110

(57) ABSTRACT

Methods that include a method comprising: providing a subterranean treatment fluid comprising an aqueous fluid, a viscosifier, a fluid loss control additive, a bridging agent comprising a degradable polymer, and a solvent; placing the subterranean treatment fluid in at least a portion of a subterranean formation; allowing the solvent to at least partially plasticize the degradable polymer; and allowing the subterranean treatment fluid to form a self-degrading filter cake upon a surface in the subterranean formation. Additional methods are provided.

### CROSS REFERENCE TO RELATED APPLICATIONS

This application is a continuation-in-part of U.S. Patent Application Publication 2005/0059556 entitled “Improved Subterranean Treatment Fluids and Methods of Treating Subterranean Formations,” filed Apr. 26, 2004, which is a continuation-in-part of U.S. Patent Application Publication 2005/0059557 entitled “Improved Subterranean Treatment Fluids and Methods of Treating Subterranean Formations,” filed Sep. 17, 2003, incorporated by reference herein for all purposes and from which priority is claimed pursuant to 35 U.S.C. § 120.

### BACKGROUND

The present invention relates to subterranean treatment operations, and more particularly, to improved subterranean treatment fluids comprising bridging agents that comprise a degradable polymer and a solvent capable of at least partially plasticizing the bridging agent, and to methods of using such improved subterranean treatment fluids in subterranean formations.

A subterranean treatment fluid used in connection with a subterranean formation may be any number of fluids (gaseous or liquid) or mixtures of fluids and solids (e.g., solid suspensions, mixtures and emulsions of liquids, gases and solids). As used herein, the term “treatment,” or “treating,” refers to any subterranean operation that uses a fluid in conjunction with a desired function and/or for a desired purpose. The term “treatment,” or “treating,” does not imply any particular action by the fluid. An example of a subterranean treatment fluid is a drilling fluid. Drilling fluids are used, inter alia, during subterranean well-drilling operations to, e.g., cool the drill bit, lubricate the rotating drill pipe to prevent it from sticking to the walls of the well bore, prevent blowouts by serving as a hydrostatic head to counteract the sudden entrance into the well bore of high pressure formation fluids, and also remove drill cuttings from the well bore. Another example of a subterranean treatment fluid is a “drill-in and servicing fluid.” “Drill-in and servicing fluids,” as referred to herein, can be understood to include fluids placed in a subterranean formation from which production has been, is being, or may be cultivated. For example, an operator may begin drilling a subterranean borehole using a drilling fluid, cease drilling at a depth just above that of a potentially productive formation, circulate a sufficient quantity of a drill-in and servicing fluid through the bore hole to completely flush out the drilling fluid, then proceed to drill into the desired formation using the well drill-in and servicing fluid. Drill-in and servicing fluids often are utilized, inter alia, to minimize damage to the permeability of such formations.

Subterranean treatment fluids generally are aqueous-based or oil-based, and may comprise additives such as viscosifiers (e.g., xanthan) and fluid loss control additives (e.g., starches). Subterranean treatment fluids further may comprise bridging agents, which may aid in preventing or reducing loss of the treatment fluid to, inter alia, natural fractures within the subterranean formation. In certain circumstances, a bridging agent may be designed to form a filter cake so as to plug off a “thief zone” (a portion of a subterranean formation, most commonly encountered during drilling operations, into which a drilling fluid may be lost). Generally, bridging agents are designed to form fast and efficient filter cakes on the walls of the well bores within the producing formations to minimize potential leak-off and damage. Generally, the filter cakes are removed before hydrocarbons are produced from the formation. Conventionally, removal has been by contacting the filter cake with one or more subsequent fluids.

Other conventional methods of removing the filter cake include formulating the subterranean treatment fluid so as to include an acid-soluble particulate solid bridging agent. The resultant filter cake formed by such subterranean treatment fluid is then contacted with a strong acid to ultimately dissolve the bridging agent. This method can be problematic, however, because the strong acid often corrodes metallic surfaces and completion equipment such as sand control screens, thereby causing such equipment to prematurely fail. Further, the acid may damage the producing formation. Additionally, the acid may cause the bridging agent to dissolve too quickly, resulting in the acid being lost into the formation, rather than completely covering the filter cake.

Another method has been to use a water-soluble particulate solid bridging agent in a subterranean treatment fluid, which is later contacted with an aqueous salt solution that is undersaturated with respect to such bridging agents. This method can be problematic, however, because such bridging agents may require a relatively long period of time to dissolve in the solutions, due to, inter alia, the presence of various gelling agents in the subterranean treatment fluids. Such gelling agents shield the water-soluble bridging agents. A further problem can be that the aqueous salt solution has a limited range of possible densities.

### SUMMARY

The present invention relates to subterranean treatment operations, and more particularly, to improved subterranean treatment fluids comprising bridging agents that comprise a degradable polymer and a solvent capable of at least partially plasticizing the bridging agent, and to methods of using such improved subterranean treatment fluids in subterranean formations.

One embodiment of the present invention is a method comprising providing a subterranean treatment fluid comprising an aqueous fluid, a viscosifier, a fluid loss control additive, a bridging agent comprising a degradable polymer, and a solvent; placing the subterranean treatment fluid in at least a portion of a subterranean formation; allowing the solvent to at least partially plasticize the degradable polymer; and allowing the subterranean treatment fluid to form a self-degrading filter cake upon a surface in the subterranean formation.

Another embodiment of the present invention is a method comprising providing a subterranean treatment fluid comprising an aqueous fluid, a viscosifier, a fluid loss control additive, a bridging agent comprising a degradable polymer, and a solvent; placing the subterranean treatment fluid in at least a portion of a subterranean formation; allowing the solvent to at least partially plasticize the degradable polymer; allowing the subterranean treatment fluid to form a self-degrading filter cake upon a surface in the subterranean formation; and allowing the filter cake to degrade.

Another embodiment of the present invention is a method comprising drilling a well bore in a subterranean formation using a subterranean treatment fluid comprising an aqueous fluid, a viscosifier, a fluid loss control additive, a bridging agent comprising a degradable polymer, and a solvent; allowing the solvent to at least partially plasticize the degradable polymer; and allowing the subterranean treatment fluid to form a self-degrading filter cake upon a surface in the subterranean formation.

The features and advantages of the present invention will be readily apparent to those skilled in the art upon a reading of the description of the preferred embodiments, which follows.

### DESCRIPTION OF PREFERRED EMBODIMENTS

The present invention relates to subterranean treatment operations, and more particularly, to improved subterranean treatment fluids comprising bridging agents that comprise a degradable polymer and a solvent capable of at least partially plasticizing the bridging agent, and to methods of using such improved subterranean treatment fluids in subterranean formations.

The subterranean treatment fluids of the present invention may comprise an aqueous fluid, a viscosifier, a fluid loss control additive, a bridging agent comprising a degradable polymer, and a solvent capable of at least partially plasticizing the degradable polymer. The term “plasticize,” or “plasticizing” as used herein, refers to the relative softening or increasing in pliability of the degradable polymer. In some embodiments, the subterranean treatment fluids may be especially useful as well drill-in and servicing fluids and may provide improved fluid loss control.

A variety of aqueous fluids may be included in the subterranean treatment fluids of the present invention. The aqueous fluid may be from any source, provided that it does not contain an excess of compounds that adversely affect other compounds in the treatment fluid. For example, a subterranean treatment fluid of the present invention may comprise freshwater, saltwater (e.g., water containing one or more salts dissolved therein), brine (e.g., saturated saltwater), seawater, or combinations thereof. Generally, the aqueous fluid is present in the subterranean treatment fluids of the present invention in an amount in the range of from about 20% to about 99% by weight. In some embodiments, the aqueous fluid is present in the subterranean treatment fluids of the present invention in an amount in the range of from about 65% to about 97% by weight.

The subterranean treatment fluids of the present invention may comprise a viscosifier. A variety of viscosifiers may be included in the subterranean treatment fluids of the present invention. Examples of suitable viscosifiers include, inter alia, biopolymers such as xanthan and succinoglycan, cellulose derivatives such as hydroxyethylcellulose, guar and its derivatives such as hydroxypropyl guar, synthetic polymers, scleroglucan, diutan, derivatives thereof, and combinations thereof. In some embodiments, the viscosifier may be present in the subterranean treatment fluids of the present invention in an amount sufficient to suspend a bridging agent and drill cuttings in the subterranean treatment fluid. More particularly, the viscosifier may be present in the subterranean treatment fluids of the present invention in an amount in the range of from about 0.01% to about 2% by weight. In some embodiments, the viscosifier may be present in the subterranean treatment fluids in an amount in the range of from about 0.13% to about 0.30% by weight.

The subterranean treatment fluids of the present invention further comprise a fluid loss control additive. A variety of fluid loss control additives can be included in the subterranean treatment fluids of the present invention, including, inter alia, starch, starch ether derivatives, hydroxyethylcellulose, cross-linked hydroxyethylcellulose, and mixtures thereof. The fluid loss control additive may be present in the subterranean treatment fluids of the present invention in an amount sufficient to provide a desired degree of fluid loss control. More particularly, the fluid loss control additive may be present in the subterranean treatment fluid in an amount in the range of from about 0.01% to about 5% by weight. In some embodiments, the fluid loss control additive is present in the subterranean treatment fluid in an amount in the range of from about 1% to about 2% by weight.

The subterranean treatment fluids of the present invention further comprise a bridging agent comprising a degradable polymer. In certain embodiments of the present invention, the bridging agent may comprise, inter alia, a degradable polymer, a mixture of a degradable polymer and calcium carbonate, a mixture of a degradable polymer and a magnesium compound (e.g., magnesium oxide), a mixture of a degradable polymer and a chemically bonded ceramic bridging agent, combinations thereof or derivatives thereof. In some embodiments, the bridging agent may become suspended in the subterranean treatment fluid and, as the subterranean treatment fluid begins to form a filter cake within the subterranean formation, the bridging agent may become distributed throughout the resulting filter cake, most preferably uniformly. In certain embodiments, the filter cake forms upon the face of the formation itself, upon a sand screen, or upon a gravel pack.

Generally, the bridging agent may be present in the subterranean treatment fluids of the present invention in an amount sufficient to create an efficient filter cake. As referred to herein, the term “efficient filter cake” will be understood to mean a filter cake comprising no material beyond that required to provide a desired level of fluid loss control. In certain embodiments, the bridging agent may be present in the subterranean treatment fluids in an amount ranging from about 0.1% to about 32% by weight. In some embodiments, the bridging agent may be present in the subterranean treatment fluids in the range of from about 3% and about 10% by weight. In certain preferred embodiments, the bridging agent may be present in the subterranean treatment fluids in an amount sufficient to provide a fluid loss of less than about 15 mL in tests conducted according to the procedures set forth by API Recommended Practice (RP) 13. One of ordinary skill in the art with the benefit of this disclosure will recognize an optimum concentration of bridging agent that provides desirable values in terms of enhanced ease of removal of the filter cake at the desired time without undermining the stability of the filter cake during its period of intended use.

As for degradable polymers, a polymer is considered to be “degradable” herein if the degradation is due to, inter alia, chemical and/or radical process such as hydrolysis, oxidation, enzymatic degradation, or UV radiation. The terms “polymer” or “polymers” as used herein do not imply any particular degree of polymerization; for instance, oligomers are encompassed within this definition. The degradability of a polymer depends, at least in part, on its backbone structure. For instance, the presence of hydrolyzable and/or oxidizable linkages in the backbone often yields a material that will degrade as described herein. The rates at which such polymers degrade are dependent on, inter alia, the type of repetitive unit, composition, sequence, length, molecular geometry, molecular weight, morphology (e.g., crystallinity, size of spherulites, and orientation), hydrophilicity, hydrophobicity, surface area, and additives. The manner in which the polymer degrades also may be affected by the environment to which the polymer is subjected (e.g., temperature, presence of moisture, oxygen, microorganisms, enzymes, pH, and the like). After the requisite time period dictated by the characteristics of the particular degradable polymer utilized, the degradable polymer is capable of undergoing an irreversible degradation downhole. The term “irreversible” as used herein means that the degradable polymer once degraded should not recrystallize or reconsolidate while downhole, e.g., the degradable polymer should degrade in situ but should not recrystallize or reconsolidate in situ. As a result, voids are created in the filter cake. Removal of the degradable polymer from the filter cake allows produced fluids to flow more freely.

Suitable examples of degradable polymers that may be used in accordance with the present invention include, but are not limited to, those described in the publication of Advances in Polymer Science, Vol. 157 entitled “Degradable Aliphatic Polyesters” edited by A.C. Albertsson, pages 1-138. Specific examples include homopolymers, random, block, graft, and star- and hyper-branched aliphatic polyesters. Such suitable polymers may be prepared by polycondensation reactions, ring-opening polymerizations, free radical polymerizations, anionic polymerizations, carbocationic polymerizations, and coordinative ring-opening polymerization for, e.g., lactones, and any other suitable process. Specific examples of suitable polymers include, but are not limited to, polysaccharides such as dextran or cellulose; chitin; chitosan; proteins; orthoesters (also known as “orthoethers”); aliphatic polyesters; poly(lactide); poly(glycolide); poly(ε-caprolactone); poly(hydroxybutyrate); poly(anhydrides); aliphatic polycarbonates; poly(orthoesters) (also known as “poly(orthoethers)”); poly(amino acids); poly(ethylene oxide); and polyphosphazenes. Of these suitable polymers, aliphatic polyesters and polyanhydrides may be preferred in many situations.

The selection of an appropriate degradable polymer may depend on the particular application and the conditions involved. Other guidelines to consider include the degradation products that result, the time for required for the requisite degree of degradation, the desired result of the degradation (e.g., voids), and the relative degree of crystallinity and amorphousness of a particular degradable polymer. Examples of other suitable degradable polymers include those degradable polymers that release useful or desirable degradation products that are desirable, e.g., an acid. Such degradation products may be useful in a downhole application, e.g., to break a viscosified treatment fluid or an acid soluble component present therein (such as in a filter cake).

Suitable aliphatic polyesters have the general formula of repeating units shown below: 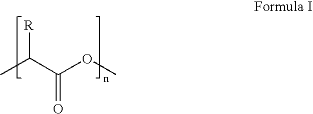
where n is an integer between 75 and 10,000 and R is a hydrogen, alkyl, aryl, alkylaryl, acetyl, heteroatoms, or mixtures thereof. Of the suitable aliphatic polyesters, poly(lactide) is preferred. Poly(lactide) is synthesized either from lactic acid by a condensation reaction or more commonly by ring-opening polymerization of cyclic lactide monomer. Since both lactic acid and lactide can achieve the same repeating unit, the general term poly(lactic acid) as used herein refers to formula I without any limitation as to how the polymer was made such as from lactides, lactic acid, or oligomers, and without reference to the degree of polymerization or level of plasticization.

The lactide monomer exists generally in three different forms: two stereoisomers L- and D-lactide and racemic D,L-lactide (meso-lactide). The oligomers of lactic acid, and oligomers of lactide are defined by the formula: 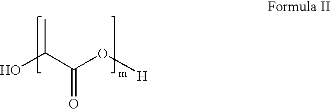
where m is an integer 2≦m≦75. Preferably m is an integer and 2≦m≦10. These limits correspond to number average molecular weights below about 5,400 and below about 720, respectively. The chirality of the lactide units provides a means to adjust, inter alia, degradation rates, as well as physical and mechanical properties. Poly(L-lactide), for instance, is a semicrystalline polymer with a relatively slow hydrolysis rate. This could be desirable in applications of the present invention where a slower degradation of the degradable polymer is desired. Poly(D,L-lactide) may be a more amorphous polymer with a resultant faster hydrolysis rate. This may be suitable for other applications where a more rapid degradation may be appropriate. The stereoisomers of lactic acid may be used individually or combined to be used in accordance with the present invention. Additionally, they may be copolymerized with, for example, glycolide or other monomers like ε-caprolactone, 1,5-dioxepan-2-one, trimethylene carbonate, or other suitable monomers to obtain polymers with different properties or degradation times. Additionally, the lactic acid stereoisomers can be modified to be used in the present invention by, inter alia, blending, copolymerizing or otherwise mixing the stereoisomers, blending, copolymerizing or otherwise mixing high and low molecular weight poly(lactides), or by blending, copolymerizing or otherwise mixing a poly(lactide) with another polyester or polyesters.

Examples of suitable orthoesters that may be used in the subterranean treatment fluids of the present invention may have a structure defined by the formula: RC(OR′)(OR″)(OR′″), wherein R′, R″, and R′″ are not hydrogen, and R′, R″, and R′″ may or may not be the same group. R′, R″, or R′″ may comprise a heteroatom that may affect the solubility of the chosen orthoester in a given application. Suitable heteroatoms could include nitrogen or oxygen. Examples of suitable orthoesters and poly(orthoesters) include, but are not limited to, orthoacetates, such as trimethyl orthoacetate, triethyl orthoacetate, tripropyl orthoacetate, triisopropyl orthoacetate, and poly(orthoacetates); orthoformates, such as trimethyl orthoformate, triethyl orthoformate, tripropyl orthoformate, triisopropyl orthoformate, and poly(orthoformates); and orthopropionates, such as trimethyl orthopropionate, triethyl orthopropionate, tripropyl orthopropionate, triisopropyl orthopropionate, and poly(orthopropionates). Suitable orthoesters also may be orthoesters of polyfunctional alcohols, such as glycerin and/or ethylene glycol. Those skilled in the art with the benefit of this disclosure will recognize suitable orthoesters that may be used in a desired application. In choosing an orthoester, one should be mindful that some orthoesters have low flash points. Therefore, the choice of which particular orthoesters to use should be guided by such considerations as environmental factors.

Optionally, in some embodiments, the degradable polymer may be crosslinked. In some embodiments, it may be desirable to include a crosslinked degradable polymer, among other purposes, to increase the impact strength, tensile strength, compressive strength, high temperature dimensional stability, creep resistance, and modulus of the degradable material.

Crosslinked degradable polymers suitable for use in the present invention may comprise any crosslinked polymer known in the art that is capable of undergoing an irreversible degradation downhole. By way of example and not limitation, certain crosslinked degradable polymers may be prepared via a two-step process that involves (1) polymerizing and/or functionalizing a degradable polymer to form a functionalized degradable polymer and (2) crosslinking the molecules of the functionalized degradable polymer. Examples of processes that may be used to prepare crosslinked degradable polymers that may be suitable for use in the present invention are described in an article entitled “Structure Modification and Crosslinking of Methacrylated Polylactide Oligomers” by Antti O. Helminen et al. in The Journal of Applied Polymer Science, Vol. 86, pages 3616-3624 (2002), and WIPO Patent Application Publication No. WO 2006/053936 by Jukka Seppälä, the relevant disclosures of which are herein incorporated by reference.

For example, a degradable polymer (e.g., a polyester or poly(lactide)) may be polymerized to include different numbers of hydroxyl functional groups, or an existing degradable polymer may be functionalized with different numbers of hydroxyl functional groups, to form a functionalized degradable polymer having one or more carbon-carbon double bonds. These functional groups may be provided via reaction of the degradable polymer with a functionalizing agent that may comprise one or more diols, polyfunctional alcohols, dicarboxylic acids, polyfunctional carboxylic acids, anhydrides, derivatives thereof, and combinations thereof. The choice of a particular functionalizing agent used may depend on several factors that will be recognized by a person of ordinary skill in the art with the benefit of this disclosure, including, but not limited to, the molecular structure and/or size of the functionalized degradable polymer desired. After at least one functionalized degradable polymer is generated, a crosslinking initiator and/or energy source may be used to form a radical at the double-bond site, and these radicals formed on different molecules of the functionalized degradable polymer may interact with each other so as to form one or more crosslinks between them. The crosslinking initiator may comprise any substance that is capable of forming a radical on the functionalized degradable polymer. Examples of suitable crosslinking initiators may include organic peroxy compounds (e.g., diazyl peroxides, peroxy esters, peroxy dicarbonates, monoperoxy carbonates, diperoxy ketals, dialkyl peroxides, sulfonyl peroxides, ketone peroxides, and peroxy carboxylic acids), inorganic peroxides (e.g., hydrogen peroxide, oxygen, ozone, and azo compounds), redox initiators, derivatives thereof, and combinations thereof. Suitable energy sources may comprise a heat source, a light source, a radiation source, and combinations thereof. The energy sources suitable for use in the present invention may vary by numerous different properties and settings, including but not limited to, wavelength of light produced, intensity of light produced, amount of heat produced, and the like. In certain embodiments, the light source may comprise an instrument that is capable of emitting blue light (e.g., light having a wavelength of about 400 nm to about 500 nm).

In certain embodiments of the present invention where this method of preparing the crosslinked degradable polymer is used, the crosslinking initiator may be formulated to remain inactive until it is “activated” by, among other things, certain conditions in the fluid (e.g., pH, temperature, etc.) and/or contact with some other substance. In some embodiments, the crosslinking initiator may be delayed by encapsulation with a coating that delays its release until a desired time or place. The choice of a particular crosslinking initiator and/or energy source will be governed by several considerations that will be recognized by one skilled in the art, including but not limited to the following: the type of functionalized degradable polymer included, the molecular weight of the functionalized degradable polymer, the pH of the treatment fluid, temperature, and/or the desired time at which to crosslink the degradable polymer. The exact type and amount of crosslinking initiator and/or the particular parameters of the energy source used depends upon the specific degradable polymer to be crosslinked, formation temperature conditions, and other factors recognized by those individuals skilled in the art, with the benefit of this disclosure.

Optionally, a crosslinking accelerator may be used, inter alia, to increase the rate at which the functionalized degradable polymers form crosslinks. Examples of suitable crosslinking accelerators that may be used include, but are not limited to, metal compounds (e.g., cobalt compounds), organic amines, and the like. The choice of whether to use a crosslinking accelerator, and, if used, the exact type and amount of the crosslinking accelerator is within the ability of those individuals skilled in the art, with the benefit of this disclosure.

The subterranean treatment fluids of the present invention further may comprise a solvent. Solvents suitable for use in the present invention should, among other things, at least partially plasticize the degradable polymer. For example, solvents suitable for use in the present invention may plasticize the degradable polymer thereby softening and/or increasing the pliability of the bridging agent. In some embodiments, this plasticization may increase the ease with which the bridging agent can be degraded. Any solvent that is capable of plasticizing a degradable polymer suitable for use in the present invention may be used. Examples of suitable solvents include, but are not limited to, methanol; ethanol; propylene carbonate; propylene glycol; polyethylene glycol; isopropanol; polyhydric alcohols such as glycerol polyethylene oxide; oligomeric lactic acid; citrate esters (such as tributyl citrate oligomers, triethyl citrate, acetyltributyl citrate, and acetyltriethyl citrate); glucose monoesters; partially fatty acid esters; PEG monolaurate; triacetin; poly(e-caprolactone); poly(hydroxybutyrate); glycerin-1-benzoate-2,3 -dilaurate; glycerin-2-benzoate-1,3-dilaurate; bis(butyl diethylene glycol)adipate; ethylphthalylethyl glycolate; glycerin diacetate monocaprylate; diacetyl monoacyl glycerol; polypropylene glycol (and epoxy derivatives thereof); poly(propylene glycol)dibenzoate, dipropylene glycol dibenzoate; glycerol; ethyl phthalyl ethyl glycolate; poly(ethylene adipate)distearate; di-iso-butyl adipate; and combinations or derivatives thereof. Additionally, in some embodiments, the solvent may be diluted by combining one or more of the above solvents with an aqueous fluid. The aqueous fluid may be fresh water, salt water, brine, or seawater, or any other aqueous based fluid that does not adversely react with the other components used in accordance with this invention or with the subterranean formation. The choice of which particular solvent to use may be determined by the particular bridging agent, the concentration of the bridging agent in the subterranean treatment fluid, and other similar factors. In certain embodiments, the solvent should be included in an amount sufficient to at least partially plasticize the degradable polymer. In some embodiments, the solvent may be included in the subterranean treatment fluids of the present invention in an amount in the range of from about 0.1% to about 99.9% by volume. In other embodiments, the solvent may be in the subterranean treatment fluids of the present invention in an amount in the range of from about 5% to about 80% by volume. In another embodiment, the solvent may be included in the subterranean treatment fluids of the present invention in an amount in the range of from about 10% to about 50% by volume.

Additionally, while halogenated solvents such as chloroform, dichloromethane, 1,2-dichlorobenzene, dimethylformamide, etc. may be used to plasticize a bridging agent, these solvents may not be desirable due to safety concerns, potential environmental issues, potential safety issues in terms of flash point and potential exposure, and relative cost.

The choice of bridging agent can depend, at least in part, on the conditions of the well, e.g., well bore temperature. For instance, in lower temperature wells, including those within the range of about 60° F. to about 150° F., it may be desirable to use a polymer that is more amorphous. Similarly, it may be desirable to use a more crystalline polymer in wells with higher temperatures.

If desired, the specific features of the bridging agent may be modified so as to maintain the filter cake's filtering capability when the filter cake is intact while easing the removal of the filter cake when such removal becomes desirable. In certain embodiments, the bridging agent has a particle size distribution in the range of from about 0.1 micron to about 1.0 millimeters. Additionally, the bridging agents in the subterranean treatment fluids of the present invention may have any shape, including but not limited to particles having the physical shape of platelets, shavings, flakes, ribbons, rods, strips, spheroids, toroids, pellets, tablets, or any other physical shape. One of ordinary skill in the art with the benefit of this disclosure will recognize the specific bridging agent and the preferred size and shape for a given application.

In some embodiments, a filter cake formed by the subterranean treatment fluids of the present invention may be a “self-degrading” filter cake as defined herein. As referred to herein, the term “self-degrading filter cake” will be understood to mean a filter cake that may be removed without the assistance of a separate “clean up” solution or “breaker” through the well bore, wherein the purpose of such clean up solution or breaker is solely to degrade the filter cake. Though the filter cakes formed by the treatment fluids of the present invention may be “self-degrading” filter cakes, an operator nevertheless occasionally may elect to circulate a separate clean up solution or breaker through the well bore under certain circumstances, such as when the operator desires to enhance the rate of degradation of the filter cake.

Optionally, the subterranean treatment fluids of the present invention also may comprise additives such as weighting agents, emulsifiers, salts, filtration control agents, pH control agents, and the like. Weighting agents are typically heavy minerals such as barite, ilmenite, calcium carbonate, iron carbonate, or the like. Suitable salts include, but not limited to, salts such as calcium chloride, potassium chloride, sodium chloride, and sodium nitrate. Examples of suitable emulsifiers include polyaminated fatty acids, concentrated tall oil derivatives, blends of oxidized tall oil and polyaminated fatty acids, and the like. Examples of suitable polyaminated fatty acids are commercially available from Halliburton Energy Services, Inc., of Houston, Tex., under the trade names “EZMUL” and “SUPERMUL.” An example of a suitable concentrated tall oil derivative is commercially available from Halliburton Energy Services, Inc., of Houston, Tex., under the trade name “FACTANT.” Examples of suitable blends of oxidized tall oil and polyaminated fatty acids are commercially available from Halliburton Energy Services, Inc., of Houston, Tex., under the trade names “INVERMUL®” and “LE MUL.” Examples of suitable filtration control agents include lignites, modified lignites, powdered resins, and the like. An example of a suitable lignite is commercially available from Halliburton Energy Services, Inc., of Houston, Tex., under the trade name “CARBONOX.” An example of a suitable modified lignite is commercially available from Halliburton Energy Services, Inc., of Houston, Tex., under the trade name “BARANEX.” An example of a suitable powdered resin is commercially available from Halliburton Energy Services, Inc., of Houston, Tex., under the trade name “BARABLOK.” Examples of suitable pH control agents include, but are not limited to mineral acids, such as hydrochloric acid; organic acids, such as formic acid and acetic acid; and bases, such as calcium hydroxide, potassium hydroxide, sodium hydroxide, and the like. In certain embodiments, the pH control agent is calcium hydroxide.

One example of a method of the present invention comprises providing a subterranean treatment fluid comprising an aqueous fluid, a viscosifier, a fluid loss control additive, a bridging agent comprising a degradable polymer, and a solvent; placing the subterranean treatment fluid in at least a portion of a subterranean formation; allowing the solvent to at least partially plasticize the degradable polymer; and allowing the subterranean treatment fluid to form a self-degrading filter cake upon a surface in the subterranean formation.

Another example of a method of the present invention comprises providing a subterranean treatment fluid comprising an aqueous fluid, a viscosifier, a fluid loss control additive, a bridging agent comprising a degradable polymer, and a solvent; placing the subterranean treatment fluid in at least a portion of a subterranean formation; allowing the solvent to at least partially plasticize the degradable polymer; allowing the subterranean treatment fluid to form a self-degrading filter cake upon a surface in the subterranean formation; and allowing the filter cake to degrade.

Another example of a method of the present invention comprises drilling a well bore in a subterranean formation using a subterranean treatment fluid comprising an aqueous fluid, a viscosifier, a fluid loss control additive, a bridging agent comprising a degradable polymer, and a solvent; allowing the solvent to at least partially plasticize the degradable polymer; and allowing the subterranean treatment fluid to form a self-degrading filter cake upon a surface in the subterranean formation.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered or modified and all such variations are considered within the scope and spirit of the present invention. In particular, every range of values (of the form, “from about a to about b,” or, equivalently, “from approximately a to b,” or, equivalently, “from approximately a-b”) disclosed herein is to be understood as referring to the power set (the set of all subsets) of the respective range of values, and set forth every range encompassed within the broader range of values. Also, the terms in the claims have their plain, ordinary meaning unless otherwise explicitly and clearly defined by the patentee.

We claim:

1. A method comprising:
providing a subterranean treatment fluid comprising an aqueous fluid, a viscosifier, a fluid loss control additive, a bridging agent comprising a degradable polymer, and a solvent;
placing the subterranean treatment fluid in at least a portion of a subterranean formation;
allowing the solvent to at least partially plasticize the degradable polymer; and
allowing the subterranean treatment fluid to form a self-degrading filter cake upon a surface in the subterranean formation.

2. The method of claim 1 wherein the solvent is not halogenated.

3. The method of claim 1 wherein the viscosifier is selected from the group consisting of biopolymers, cellulose, cellulose derivatives, guar, guar derivatives, synthetic polymers and mixtures thereof.

4. The method of claim 1 wherein the fluid loss control additive is selected from the group consisting of starch, starch ether derivatives, hydroxyethylcellulose, cross-linked hydroxyethylcellulose, and mixtures thereof.

5. The method of claim 1 wherein the degradable polymer is selected from the group consisting of aliphatic polyesters, poly(lactides), poly(glycolides), poly(ε-caprolactones), poly(hydroxy ester ethers), poly(hydroxybutyrates), poly(anhydrides), polycarbonates, poly(orthoesters), poly(amino acids), poly(ethylene oxides), poly(phosphazenes), poly ether esters, polyester amides, polyamides, and copolymers, combinations, and derivatives thereof.

6. The method of claim 1 wherein the bridging agent is present in the subterranean treatment fluids in an amount ranging from about 0.1% to about 32% by weight.

7. The method of claim 1 wherein the solvent is selected from the group consisting of methanol, ethanol, propylene carbonate, propylene glycol, polyethylene glycol, isopropanol, polyhydric alcohols, oligomeric lactic acid, citrate esters, glucose monoesters, partially fatty acid esters, PEG monolaurate, triacetin, poly(e-caprolactone), poly(hydroxybutyrate), glycerin-1-benzoate-2,3-dilaurate, glycerin-2-benzoate-1,3-dilaurate, bis(butyl diethylene glycol)adipate, ethylphthalylethyl glycolate, glycerin diacetate monocaprylate, diacetyl monoacyl glycerol, polypropylene glycol, poly(propylene glycol)dibenzoate, dipropylene glycol dibenzoate, glycerol, ethyl phthalyl ethyl glycolate, poly(ethylene adipate)distearate, di-iso-butyl adipate, and combinations or derivatives thereof.

8. The method of claim 1 wherein the solvent is present in the subterranean treatment fluid in an amount in the range of from about 5% to about 80% by volume of the subterranean treatment fluid.

9. A method comprising:
providing a subterranean treatment fluid comprising an aqueous fluid, a viscosifier, a fluid loss control additive, a bridging agent comprising a degradable polymer, and a solvent;
placing the subterranean treatment fluid in at least a portion of a subterranean formation;
allowing the solvent to at least partially plasticize the degradable polymer;
allowing the subterranean treatment fluid to form a self-degrading filter cake upon a surface in the subterranean formation; and
allowing the filter cake to degrade.

10. The method of claim 9 wherein the solvent is not halogenated.

11. The method of claim 9 wherein the degradable polymer is selected from the group consisting of aliphatic polyesters, poly(lactides), poly(glycolides), poly(ε-caprolactones), poly(hydroxy ester ethers), poly(hydroxybutyrates), poly(anhydrides), polycarbonates, poly(orthoesters), poly(amino acids), poly(ethylene oxides), poly(phosphazenes), poly ether esters, polyester amides, polyamides, and copolymers, combinations, and derivatives thereof.

12. The method of claim 9 wherein the degradable polymer is crosslinked.

13. The method of claim 9 wherein the solvent is selected from the group consisting of methanol, ethanol, propylene carbonate, propylene glycol, polyethylene glycol, isopropanol, polyhydric alcohols, oligomeric lactic acid, citrate esters, glucose monoesters, partially fatty acid esters, PEG monolaurate, triacetin, poly(e-caprolactone), poly(hydroxybutyrate), glycerin-1-benzoate-2,3-dilaurate, glycerin-2-benzoate-1,3-dilaurate, bis(butyl diethylene glycol)adipate, ethylphthalylethyl glycolate, glycerin diacetate monocaprylate, diacetyl monoacyl glycerol, polypropylene glycol, poly(propylene glycol)dibenzoate, dipropylene glycol dibenzoate, glycerol, ethyl phthalyl ethyl glycolate, poly(ethylene adipate)distearate, di-iso-butyl adipate, and combinations or derivatives thereof.

14. The method of claim 9 wherein the solvent is present in the subterranean treatment fluid in an amount in the range of from about 5% to about 80% by volume of the subterranean treatment fluid.

15. A method comprising:
drilling a well bore in a subterranean formation using a subterranean treatment fluid comprising an aqueous fluid, a viscosifier, a fluid loss control additive, a bridging agent comprising a degradable polymer, and a solvent;
allowing the solvent to at least partially plasticize the degradable polymer; and
allowing the subterranean treatment fluid to form a self-degrading filter cake upon a surface in the subterranean formation.

16. The method of claim 15 wherein the viscosifier is selected from the group consisting of biopolymers, cellulose, cellulose derivatives, guar, guar derivatives and synthetic polymers.

17. The method of claim 15 wherein the fluid loss control additive is selected from the group consisting of starch, starch ether derivatives, hydroxyethylcellulose, cross-linked hydroxyethylcellulose, and mixtures thereof.

18. The method of claim 15 wherein the degradable polymer is selected from the group consisting of aliphatic polyesters, poly(lactides), poly(glycolides), poly(ε-caprolactones), poly(hydroxy ester ethers), poly(hydroxybutyrates), poly(anhydrides), polycarbonates, poly(orthoesters), poly(amino acids), poly(ethylene oxides), poly(phosphazenes), poly ether esters, polyester amides, polyamides, and copolymers, combinations, and derivatives thereof.

19. The method of claim 15 wherein the degradable polymer is crosslinked.

20. The method of claim 15 wherein the solvent is selected from the group consisting of methanol, ethanol, propylene carbonate, propylene glycol, polyethylene glycol, isopropanol, polyhydric alcohols, oligomeric lactic acid, citrate esters, glucose monoesters, partially fatty acid esters, PEG monolaurate, triacetin, poly(e-caprolactone), poly(hydroxybutyrate), glycerin-1-benzoate-2,3-dilaurate, glycerin-2-benzoate-1,3-dilaurate, bis(butyl diethylene glycol)adipate, ethylphthalylethyl glycolate, glycerin diacetate monocaprylate, diacetyl monoacyl glycerol, polypropylene glycol, poly(propylene glycol)dibenzoate, dipropylene glycol dibenzoate, glycerol, ethyl phthalyl ethyl glycolate, poly(ethylene adipate)distearate, di-iso-butyl adipate, and combinations or derivatives thereof.
